(19) United States
(12) Patent Application Publication
(10) Pub. No.: US 2015/0112991 A1
(43) Pub. Date: Apr. 23, 2015

(54) INLINE HIERARCHY METHOD AND SOFTWARE, AND BUSINESS METHODS THEREFORE

(71) Applicant: LINKIES, LLC, Royal Oak, MI (US)

(72) Inventors: Chad S. Priest, Warren, MI (US); Brian T. Barris, Dearborn, MI (US); Matthew J. Howe, Farmington Hills, MI (US)

(21) Appl. No.: 14/382,540

(22) PCT Filed: Mar. 1, 2013
(86) PCT No.: PCT/US2013/028756

§ 371 Date: Sep. 2, 2014

Related U.S. Application Data
(60) Provisional application No. 61/605,543, filed on Mar. 1, 2012.

(51) Int. Cl. G06F 17/30

(52) U.S. Cl. CPC G06F 17/30589; G06F 17/30598
USPC 707/737

(57) ABSTRACT

An inline hierarchical method and software is disclosed that includes expanding a conventional data hierarchy beyond a parent-child relationship that opens up new searching, correlating, analyzing and displaying options, creating new levels of grouping various identifiers. This software derives a multiple tiered hierarchical structure from user-defined and/or computer determined inline tags within an element or multiple elements of an object, as well as business methods therefore. Grouping these tags together in new ways provides increased flexibility in data management not achievable before.

### BACKGROUND OF THE INVENTION

1. Field of the Invention

The present invention relates to a method of using and storing data objects, and to software for displaying and managing data objects. More particularly, the invention relates to a new system of software, and a method of using same, that derives a multiple tiered hierarchical structure from user-defined inline tags within an element or multiple elements of an object, as well as business methods therefore.

2. Description of the Prior Art

Prior art software systems have employed a wide variety of folksonomy and classification systems to allow users to define and categorize content on the web. Conventional systems have included the use of hashtags which are utilized on a variety of social networking sites such as Twitter, Instagram, and Tumblr. Sites that employ folksonomy are able to create a two tiered hierarchy where the first tier is generally denoted as the descriptive tag, and the second tier is generally referred to as the child content of that tag. This parent-child relationship allows for discovery of related content that shares the same tag.

Although it might now appear to anyone that anything can be searched and the resulting data can be managed in any way a user may like, these prior art systems actually have had limited success in their ability to manage data, and correlate that data. For example, data being entered into a computer is usually categorized by an algorithm with pre-determined classifications, which is inherently limiting, because the pre-determined classifications are limiting themselves. The generally inherent problem in these services and current forms of folksonomy, is the inability to organize, provide tag definition, and group or associate similarly related tags into a broader category. In the industry, there does not appear to be any software to provide such an expansion, and consequently, previous answers to this dilemma are unknown by the present inventors.

### SUMMARY OF THE INVENTION

To expand the possibilities of searching and correlating data, the present inventors have invented novel software that by adds at least one more tier to the conventional hierarchy model, creating a new model with unexpectedly good results that is now able to to hierarchically group user-defined hashtags, while maintaining the current user-defined inline method that hashtags use. This novel system benefits users with increased relevancy, organizational display and management tools. Even further benefits include exponentially increased discovery of content that is related to multiple tags, much greater further definition of and contextual meaning of tags and content, as well as the creation of further reaching associations and relationships between tags that could belong in the same category.

Although the invention will be described by way of examples herein below for specific aspects having certain features, it must also be realized that minor modifications or alterations that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects, which may be apparent to those of ordinary skill in the art, all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1 illustrates an example network in which the present invention may be implemented in one aspect.

FIG. 2 is a flow chart illustrating a procedure for parsing and storing object data including user-defined identifiers and all associated elements in accordance with one aspect of the present invention.

FIG. 2A is a flow chart illustrating a procedure for creating and retaining an external network connection to a content sever in accordance with one aspect of the present invention.

FIG. 2B is a flow chart illustrating a procedure for creating a user's library entry, retaining associations with its elements and user-defined identifiers, checking for subscribers of the user's library and updating the subscribers' subscription libraries in accordance with one aspect of the present invention.

FIG. 2C is a flow chart illustrating a procedure for updating subscription libraries.

FIG. 3 illustrates an example of parsing several different objects from multiple content servers to create and retain multiple library entries in a user's library in accordance with a specific implementation of the present invention.

FIG. 3A shows an image post, user created object.

FIG. 4 is an expanded view of the parent grouping identifier that illustrates all grouping identifiers' associations with its elements, user identifiers and network details retained by the library content server in accordance with one aspect of the present invention.

FIG. 4A is an illustration of deriving relationships and associations from user libraries.

FIG. 5 is an illustration of the hierarchy of a user library in accordance with one aspect of the present invention.

FIG. 6 is a flow chart illustrating user interaction with a user library in accordance with one aspect of the present invention.

FIG. 7 is an example user library profile view in accordance with one aspect of the present invention.

FIG. 8 is a flow chart illustrating user interaction with parent grouping identifiers in accordance with one aspect of the present invention.

FIG. 9 illustrates an example computer system in which specific aspects of the present invention may be implemented.

FIG. 10 illustrates one way we can determine and apply a rank to parent grouping identifiers and its grouping identifiers.

FIG. 11 illustrates example ranking/display order of parent grouping identifiers and grouping identifiers based on FIG. 10.

FIG. 12 illustrates example values and basic structure that are associated with parent to grouping identifiers and grouping identifiers for analytic purposes.

FIG. 13 is a flow chart illustrating a notification system.

FIG. 14 illustrates how targeted advertisements can be displayed for parent grouping identifiers and grouping identifiers.

FIG. 15 illustrates how promoted advertisements can be displayed for parent grouping identifiers.

FIG. 16 illustrates parent grouping identifiers and it's grouping identifiers being embedded on a third party website.

### DETAILED DESCRIPTION OF THE INVENTION

In accordance with the present invention, the present inventors disclose herein a new expanded software and method of implementing the same with an enhanced ability to organize, provide tag definition, and group or associate similarly related tags into a broader category. The invention includes a new system of software, and a method of using same, that derives a multiple tiered hierarchical structure from user-defined or computer determined inline tags within an element or multiple elements of an object, as well as describing business methods that embody the new software and methods. The new software accomplishes this new multiple tiered hierarchical structure by finding, parsing, collecting, organizing, and storing objects and its elements into an expanded tier system. Once stored, such objects, elements, and identifiers can be displayed, managed, analyzed, defined, associated, and/or embedded, as will be described more fully hereinbelow.

Reference will now be made to specific aspects of the invention. Examples of these aspects are illustrated in the accompanying drawings described in greater detail below. In the interests of brevity, the ensuing descriptions include well known process operations that have not been described in detail in order to not unnecessarily obscure the present invention. Certain aspects of the present invention provide mechanisms for creating and managing a user library around a variety of different user-defined or computer determined identifiers, and elements. Initially, a user may define, or a computer may determine by automated process, an identification or create an object on a content server. Thereafter, the object may be organized in any suitable manner to expand its capabilities.

### I. DEFINITIONS

While describing the new software and methods within this Detailed Description, we will be using many terms that have new meanings as well as conventional meanings. Initially, these definitions will describe representative examples, but shall not be limited thereto. With that in mind, we proceed to provide such examples and definitions, as follows.

A user may identify or create an object, and that object may take any suitable form, such as a person, including a representation of a person and/or any information related to a particular person; a place including a representation of a place and/or geographical information; a thing such as an inanimate object which does not have a representation as a person or a place; an object which has an analog in the real world; a virtual object; or an event that may represent a specific time, place, person, and/or group. The objects may be defined by the user or may be computer determined. Either way, the object may consist of various elements.

Such elements may take any suitable form that can relate to the new object. An element can generally be stored as information that can be retrieved and experienced by a person. For example, an element may take many forms, such as a form of an image, a photograph or an advertisement; a video like a documentary, television show, movie, video clip, advertisement; a Universal Resource Locator or URL; some text like an article; a blog entry, book, book excerpt, quote, email or instant message or a social networking update; files; folders; attributes such as a file name, title, file size, computer instructions, meta data, binary code, color, or size, or any combination thereof. Further, these elements may pertain to anything, such as a person, a group of people, a thing like a photo of a book, an inanimate or virtual object, or an event. In other words, they may have the same attributes as listed above with respect to the example objects.

An identifier can be any of the following, although it is not limited to, a parent grouping identifier, grouping identifier or user identifier. As discussed above, the identifier may also be at any level of the hierarchy beyond a parent grouping identifier, such as a to grandparent identifier, or anything higher in the hierarchy. These identifiers can be made up of any type of syntax, pattern, delimited strings, tags, keywords, hashtags, categories or any type of meta data or text.

First, the identifier may be a parent grouping identifier, a grouping identifier or a user identifier that may identify objects and elements in any suitable form, such as a person, including a representation of a person and/or any information related to a particular person, a place, including a representation of a place and/or geographical information, a thing like an inanimate object which does not have a representation as a person or a place, an object which has an analog in the real world, a virtual object, or an event representing a specific time, place, person, and/or group. Any suitable identifier may be utilized. Every type of identifier uses a unique syntax to determine what type of identifier it is. Some examples of these are shown below within the written descriptions of the drawings and within the drawings themselves.

An instruction can be made up of, but is not limited to, any type of pattern, delimited string, code, or the like. Instructions are designed for the purpose of commanding a program to complete a task. An instruction may or may not be human-readable.

A user library is a collection of library entries, identifiers, content server data, user identifiers, instructions, objects, and/or elements for a single user. A user can be any entity or automated process requesting data.

A library entry is an object that may or may not include parent grouping identifiers, grouping identifiers, user identifiers, elements, instructions and/or content server data. It may or may not be imported from external content servers or from the library content server.

A user subscription library is a collection of library entries, identifiers (including but not limited to parent grouping identifiers, grouping identifiers), content server data, user identifiers, instructions, and elements from other users' libraries in accordance with the user's subscription details.

User subscription details are records of the parts of another user's user library that they subscribed to. These details may or may not include parent grouping identifiers, grouping identifiers, user identifiers, instructions, elements, or content server data.

User subscribers are other users who wish to receive either a part of or a complete user's library.

Within such an object, element or identifier, user-defined grouping identifiers, parent grouping identifiers, grandparent grouping identifiers or the like, and user identifiers may or may not be used. Also within the object, there may be one or more associated elements, around which the user may wish to add a newly introduced object, element or applied identifier to their user library. For example, a user may apply the grouping identifier “#skateboarding” to a new object on a content server. The user may also use multiple identifiers within an object. For example, a user may apply a parent grouping identifier “(#skate)” and grouping identifiers “#video” and “#tricks” within the same object. The grouping identifiers “#video” and “#tricks” are associated as children of the parent grouping identifier “(#skate)” forming a hierarchy in the user's library. This hierarchy may be expanded to grandparents, great-grandparents, or any advantageous level of hierarchy that is desired, and still be within the scope of this invention.

The user can add new objects and elements to the same parent grouping identifiers, grouping identifiers and user identifiers by using a diverse or heterogeneous mix of content servers and applications. For example, a user may identify the same object “#skateboarding” with respect to numerous data types, including, for example, photographs, videos, text, graphics, and the like. The element contributions for a particular object become part of the user's library for such object, which is then retained, and may become accessible and modifiable by the user. Each user's library may be organized by the different user-defined or computer determined parent grouping identifiers as well as the grouping identifiers and/or the user identifiers while retaining all associated elements with the corresponding identifiers.

Interested users can view particular user libraries and browse or search for particular user libraries or identifiers and their associated elements, user identifiers and content server data. Interested users may also subscribe to another user's complete user library or to certain parent grouping identifiers and/or grouping identifiers. This subscription may be stored as a library by the interested user.

Prior to describing detailed mechanisms for managing user libraries, objects, elements, instructions, users' subscriptions, the user-defined or computer determined identifiers and content server data, a computer network architecture will first be briefly described to provide an example context for practicing techniques of the present invention.

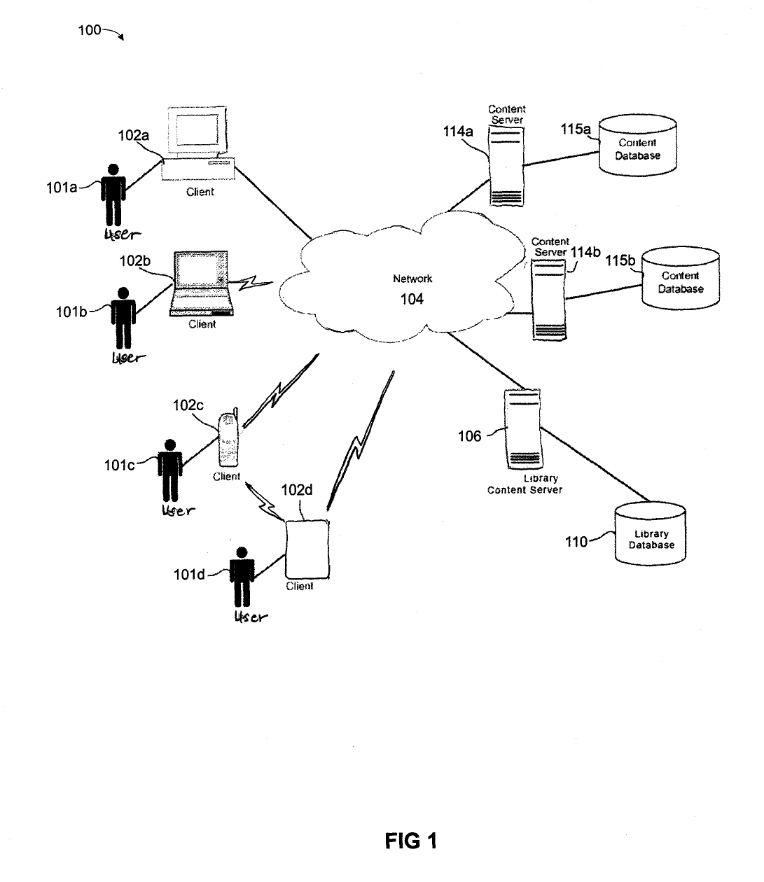

FIG. 1 illustrates an example network segment generally denoted by the numeral 100, in which the present invention may be implemented in accordance with one aspect of the present invention. As shown, a plurality of clients 102a-d may access various content servers, for example, content servers 114a or 114b or library content server 106 via network 104. Applications may be implemented on any number of servers although only two content servers 114a and 114b are illustrated for clarity and simplification of the description. Each server (e.g., 114a, 114b, 106) may have access to one or more databases, e.g., 115a, 115b, or 110, into which objects or user library information is retained. The storage of the user's library can also be stored within any storage device, including, but not limited to, databases, computer disks, ram memory, computer memory, flash drives or the like.

The network may take any suitable form, such as a wide area network or Internet or one or more local area networks (LANs). Network 104 may include any suitable number and type of devices, e.g., routers and switches, for forwarding requests from each client to a particular server application, forwarding application results back to the requesting clients or forwarding data between various servers.

Further aspects of the present invention may also be practiced in a wide variety of network environments, represented by network 104, including, for example, TCP/IP based networks, e.g., Rate Control Protocol or RCP, Transport Control Protocol or TCP, Fast TCP, Stream-based TCP/IP or STCP, explicit Control Protocol or XCP, telecommunications networks, wireless networks, or mobile networks, in addition, the computer program instructions with which aspects of the invention are implemented may be stored in any type of computer-readable media, and may be executed according to a variety of computing models including a client/server model, a peer-to-peer model, on a stand-alone computing device, or according to a distributed computing model in which various functionalities described herein may be affected or employed at different locations.

A content server may take any suitable form for storing or accessing any suitable object. In one implementation, a content server may implement a communication application such as email, instant messaging, social networking, blogging, or IP telephony. A communication application generally allows a user, whether human or automated entity, to communicate with one or more other users via a communication device, such as by telephone, personal digital assistant, PDAs, or computers via one or more networks and retain user communication information, for example, in database 115a. Aspects of the present Invention may be employed with respect to communication data obtained from communication server applications or generated from any communication application, such as general communication applications that include Twitter, Facebook, Google+ or any other commonly used application.

In another example implementation, a content server may implement a mechanism for retaining object information, for example, in database 115b, regarding various types of elements. By way of example, the content server may implement a photograph or video organization application.

Another aspect of the present invention may include library content server 106 for creating and managing dynamic user libraries. The library content server 106 may be implemented within another application server, such as a content server 114a or 114b or on a separate server, such as the illustrated library content server 106. In general, the library content server 106 is configured to allow the creation and management of dynamic user libraries based on user-defined identifiers, objects and related elements. The library content server 106 may access one or more library databases, for example, database 110, for storing representational information regarding library entries, user-defined identifiers, objects, related elements, community members, users, etc. Mechanisms for creating and managing user libraries for elements across diverse content servers can be implemented in any suitable manner.

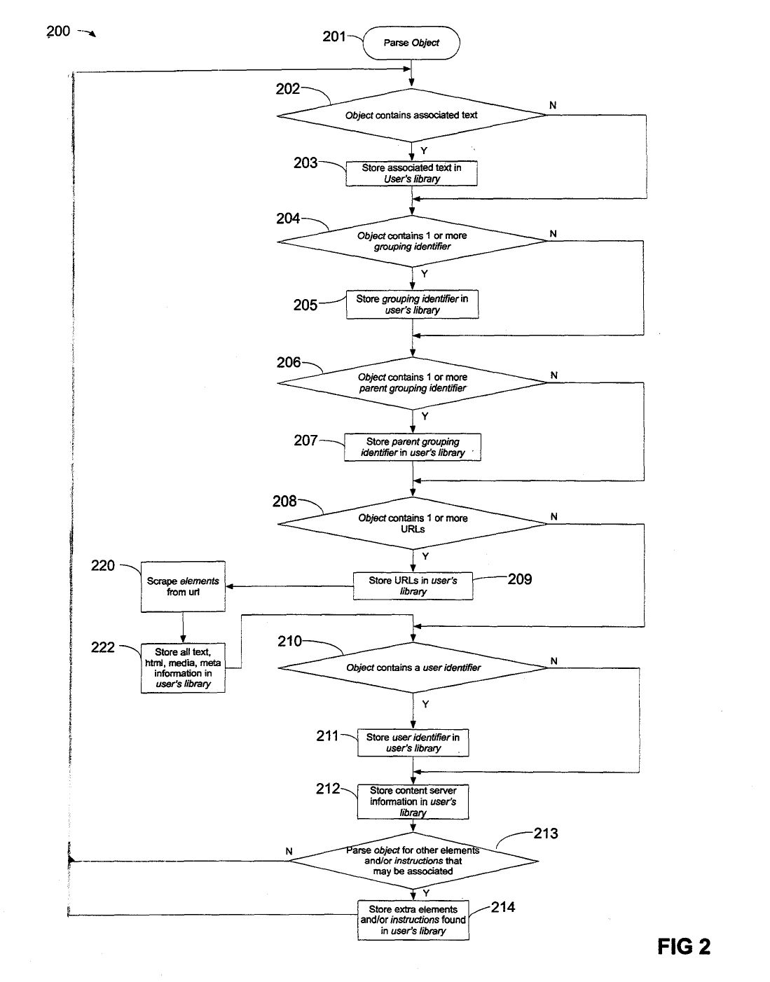

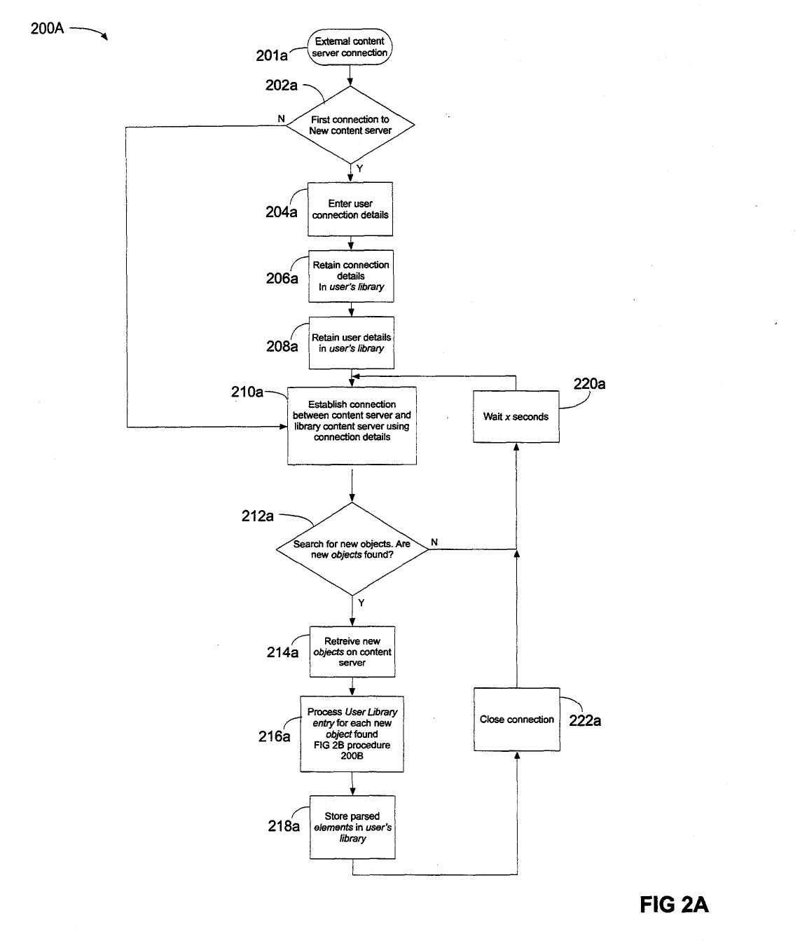

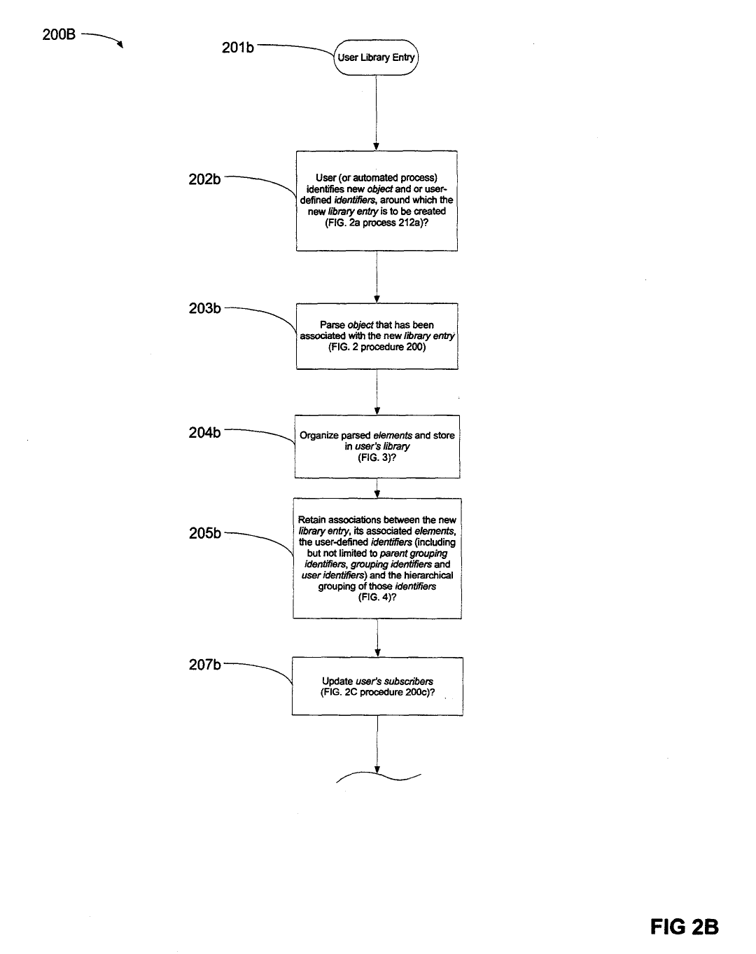

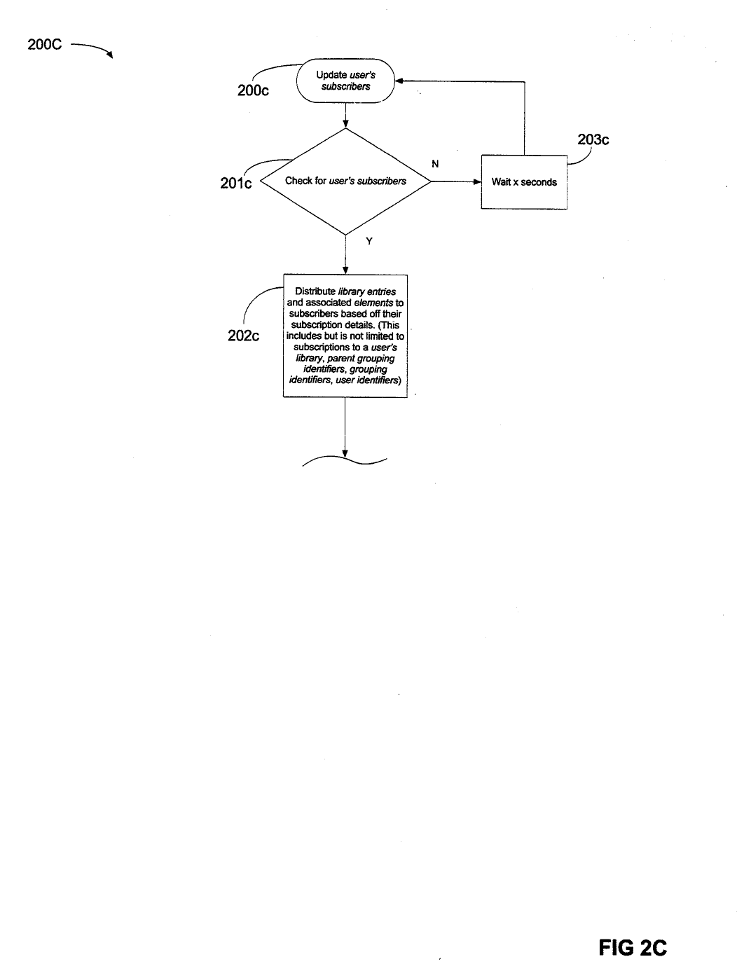

FIG. 2 is a flow chart illustrating a procedure 200 for parsing associated text, grouping identifiers, parent grouping identifiers, user identifiers, URLs, content server information, including user details, or any other associated elements from a new object in accordance with the present invention. After a new object is introduced to the library content server 106, the object is parsed 201 to find associated elements.

If associated text 202 is found after parsing, it is stored via step 203 as an element in the user's library. Otherwise, this operation may be skipped. If grouping identifiers are found after parsing, step 204 is initiated and they are stored as elements in the user's library in step 205. Otherwise, this operation may likewise be skipped. Then, if parent grouping identifiers are found after parsing, step 206 is followed, they are stored in mechanism 207 as elements in the user's library. Otherwise this operation may be skipped. If URLs are found after parsing step 208, mechanism 209 stores them as elements in the user's library. Each URL found is then visited by a web-crawling spider/bot to retrieve any additional elements 220 from the URL. Additional elements from visited URLs may also include html, css, meta data, videos, images, flash, etc. That information is then stored in the user's library. If no URLs are found, process steps 209, 220 and 222 may be skipped. If user identifiers are found after parsing step 210, they are stored as elements in the user's library. This operation may also be skipped. The content server details and the associated user details (from the content server) are then stored in the user's library in step 212. The content server details are associated with the user and may include personal information. The object is then searched for any additional elements and/or instructions that may be associated with it in step 213, and if found, storage step 214 in the user's library will record the object.

FIG. 2A is a flow chart illustrating a procedure generally denoted as 200A for creating a connection to a remote or a local content server, serving objects and retaining the connection details so that the library content server 106 of FIG. 1 can find new objects a user has created in accordance with an aspect of the present invention. Initially, it is determined whether the user has ever connected 202a to the content server. If this is the first connection, the user may enter their content server connection details 204a. The content server then grants the users library content server 106 of FIG. 2 the ability to access some or all of the user's objects and user details. The library content server 106 then retains all of the content server connection details 206a and then retains the user details 208a in the library database 110. Otherwise this operation may be skipped.

When a content server connection has been made in a process 210a that has been initiated by the user or in an automated process, the library content server 106 attempts to find any and all new objects 212a that a user may have created on the content server. If no new objects are found, the library content server 106 may wait x seconds 220a before attempting to connect again. If new objects have been found, the library content server 106 retrieves them in process step 214a and processes them as 216a using FIG. 2B procedure 200B. The library content server 106 stores the processed objects, all related elements and the user-defined identifiers into a user's library in process 218a. The library content server 106 then closes the connection to the content server 222a and then waits x seconds 220a before reconnecting 210a to the content server and repeating the process.

FIG. 2B is a flow chart illustrating a procedure 200B for creating, and/or storing elements, aggregating user-defined identifiers, and updating subscription libraries for a user's library entry in accordance with an aspect of the present invention. Initially, a user, or an automated process, may identify a new object, which may be associated with one or more elements and user-defined identifiers, around which a new library entry is to be created in process 202b using a process 212a, as seen in FIG. 2A. The user-defined identifiers can be any combination of parent grouping identifiers, grouping identifiers and/or user identifiers. All objects are then parsed in step 203b using the procedure 200 of FIG. 2A.

After the object is parsed, the elements, user details and identifiers are organized and stored via step 204b in the library database 110 of FIG. 1. The library database 110 retains associations 205h between the new library entry, its associated elements, the user-defined identifiers (including parent grouping identifiers, grouping identifiers and user identifiers) and the hierarchical grouping of those identifiers. After all associations and elements are stored, the library content server 106 updates the subscription libraries of the user's subscribers 207b using FIG. 2C procedure 200c.

FIG. 2C is a flow chart illustrating a procedure generally denoted by the numeral 200C for updating subscription libraries for a user's subscribers. First, the library content server 106 checks to see if the user has any subscribers 201.c. If subscribers are found, the library content server 106 then distributes any library entries and associated elements 202c that have not yet been distributed to subscribers. The distribution of the library entries is based on the subscriber's subscription details. These subscription details may include, but are not limited to, a user's library, parent grouping identifiers, grouping identifiers and user identifiers. Otherwise this operation waits x seconds 203c before repeating.

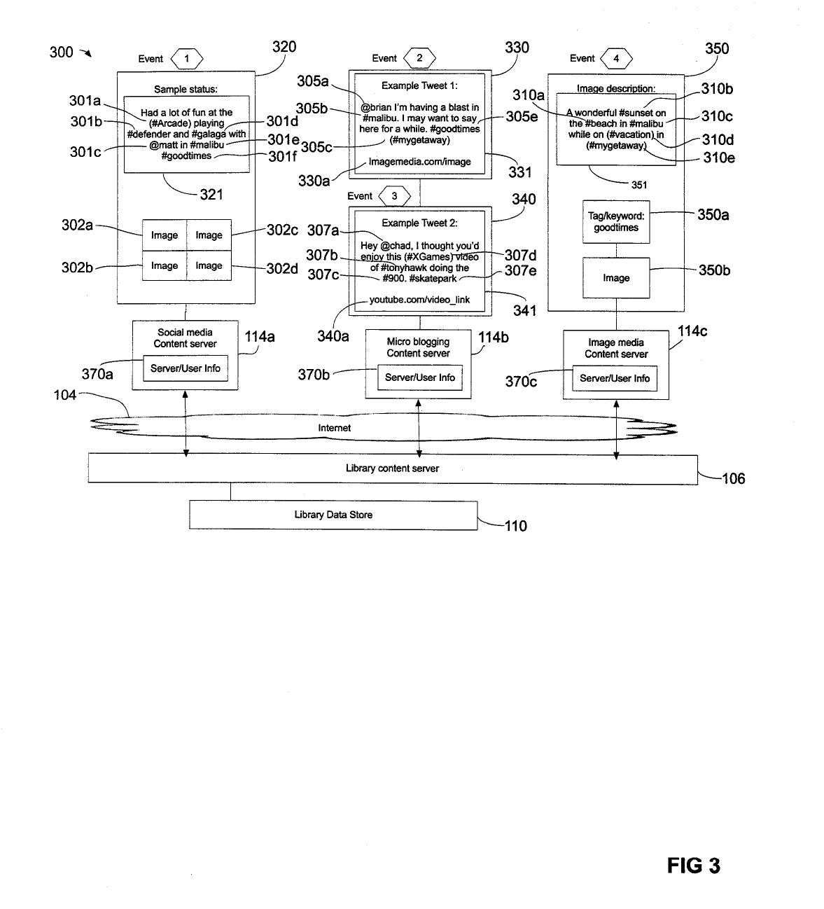

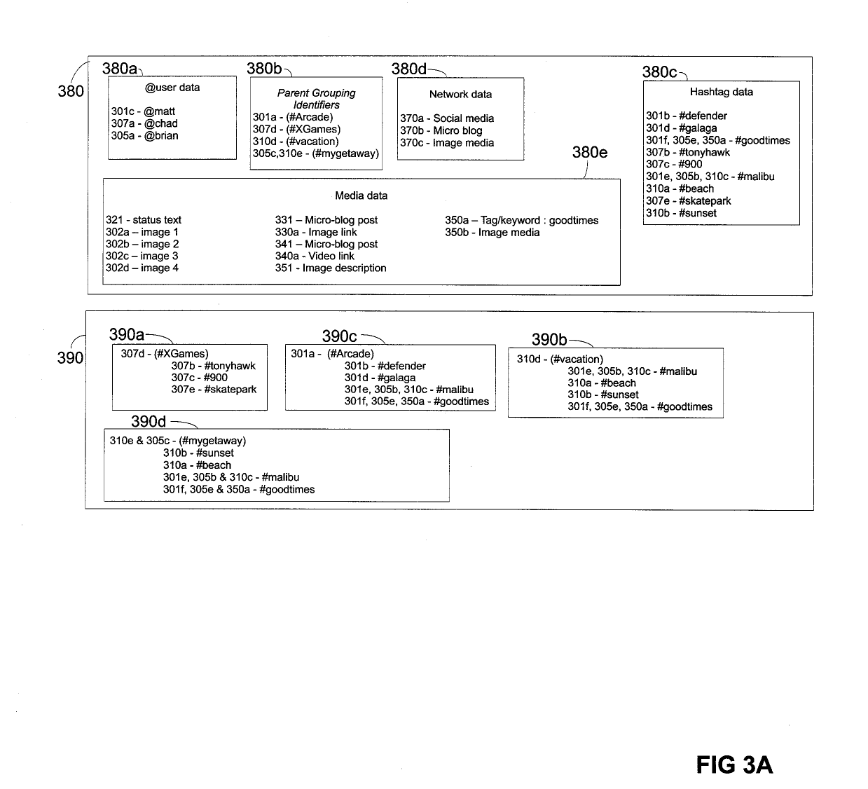

FIG. 3 is a diagrammatic illustration another aspect of the present invention in which four separate object events are created for a single user on three different content servers, and with the processing of each object, its associated elements and user-defined identifiers are stored in the example user's library 380 in FIG. 3A in accordance with a specific implementation of the present invention. Any number of objects may be implemented on any number of content servers, although only three content servers and four object creation events are illustrated here for clarity and simplification.

In the first event, a user creates an object 320 in the form of a status update to the social media content server 114a. The user, or an automated process, connects the library content server 106 to the social media content server 114a via network 104 104 using FIG. 2A's procedure 200a. Once a connection has been made to the social media content server 114a, the library content server 106 parses, as in procedure 200 of FIG. 2, the object 320 to discover associated identifiers and elements. The associated text element 321 and image elements 302a-302d are stored in the user's library 380, table 380e. User-defined parent grouping identifier “(#Arcade)'” 301a, grouping identifiers “#defender” 301b, “#galaga” 301d, “#malibu” 301e, “#goodtimes” 301f and user identifier “@chad” 301c contained within text element 321 are also stored. The parent grouping identifier “(#Arcade)” 301a is stored in the user's library 380, table 380b. The grouping identifiers “#defender” 301b, “#galaga” 301d, “#malibu” 301e and “#goodtimes” 301f are stored in the user's library 380, table 380c. The grouping identifiers 301b, 301d, 301e, 301f are associated with the parent grouping identifier 301a as shown in 390c. The social media content server user data and network information 370a is stored in the user's library 380, table 380d. The user identifier “@chad” 301c is stored in the user's library 380, table 380a. All elements from within object 320 including text element 321, image elements 302a-302d, user identifier 301c, and social media content server user data and network information 370a retain their association with the grouping identifiers 301b, 301d, 301e, 301f.

In the second event shown in FIG. 3, a user creates an object 330 in the form of a micro-blog update to the micro-blogging content server 114b. The user, or an automated process, connects the library content server 106 to the micro-blogging content server 114b via network 104 using procedure 200a of FIG. 2A. Once a connection has been made to the micro-blogging content server 114b, the library content server 106 parses object 330 to discover associated identifiers and elements. The associated text element 331 and URL element 330a is stored in the user's library 380, table 380e. User-defined parent grouping identifier “(#mygetaway)” 305c, grouping identifiers “#malibu” 305b, “#goodtimes” 305e and user identifier “@brian” 305a contained within text element 331 are also stored. The parent grouping identifier “(#mygetaway)” 305c is stored in the user's library 380, table 380b. The grouping identifiers “#malibu” 305b and “#goodtimes” 305e are stored in the user's library 380, table 380c. The grouping identifiers 305b, 305e are associated with the parent grouping identifier 305c as shown in 390d. The micro-blogging content server user data and network information 370b is stored in the user's library 380, table 380d. The user identifier “@brian” 305a is stored in the user's library 380, table 380a. All elements from within object 330 including, text element 331, URL element 330a, user identifier 305a, and micro-blogging content server user data and network information 370b retain their association with the grouping identifiers 305b, 305e.

In the third event 350 of FIG. 3, a user creates an object 340 in the form of a micro-blog update to the micro-blogging content server 114b. The user connects the library content server 106 to the micro-blogging content server 114b via network 104 using procedure 200a of FIG. 2A. Once a connection has been made to the micro-blogging content server 114b, the library content server 106 parses the object 340 to discover associated identifiers and elements. The associated text element 341 and URL element 340a is stored in the user's library 380, table 380e. User-defined parent grouping identifier “(#XGames)” 307d, grouping identifiers “#tonyhawk” 307b, “#900” 307c, “#skatepark” 307e and user identifier “@chad” 307a contained within text element 341 are also stored. The parent grouping identifier “(#XGames)” 307d is stored in the user's library 380, table 380b. The grouping identifiers “#tonyhawk” 307b, “#900” 307c and “#skatepark” 307e are stored in the user's library 380, table 380c. The grouping identifiers 307b, 307c, 307e are associated with the parent grouping identifier 307d as shown in 390a. The micro-blogging content server user data and network information 370b is stored in the user's library 380, table 380d. The user identifier “@chad” 307a is stored in the user's library 380, table 380a. All elements from within object 340 including text element 341, URL element 340a, user identifier 307a, and micro-blogging content server user data and network information 370b retain their association with the grouping identifiers 307b, 307c, 307e.

In the fourth event of FIGS. 3 and 3a, a user creates an object 350 in the form of an image post to the image media content server 114c. The user, or an automated process, connects the library content server 106 to the image media content server 114c via network 104 using FIG. 2A's procedure 200a. Once a connection has been made to the image media content server 114c, the library content server 106 parses the object 350 to discover associated identifiers and elements. The associated text element 351, the tag/keyword “goodtimes” 350a and image element 350b are stored in the user's library 380, shown in FIG. 3A, in table 380e. The tag/keyword is also used as a grouping identifier. User-defined parent grouping identifiers “(#mygetaway)” 310e and “(#vacation)” 310d, grouping identifiers “#sunset” 310b, “#beach” 310a and “malibu” 310c contained within text element 351 are also stored. The parent grouping identifiers “(#mygetaway)” 310e and “(#vacation)” 310d is stored in the user's library 380, table 380b. The grouping identifiers “#sunset” 310b, “#beach” 310a, “#malibu” 310c and “#goodtimes” 350a are stored in the user's library 380, table 380c. The grouping identifiers 310b, 310a, 310c, 350a are associated with the parent grouping identifiers 310d and 310e as shown in 390b and 390d. The image media content server user data and network information 370c is stored in the user's library 380, table 380d. All elements from within object 350 including text element 351, the tag/keyword “goodtimes” 350a, image element 350b, image media content server user data and network information 370c retain their associations with the grouping identifiers 310b, 310a, 310c, 350a.

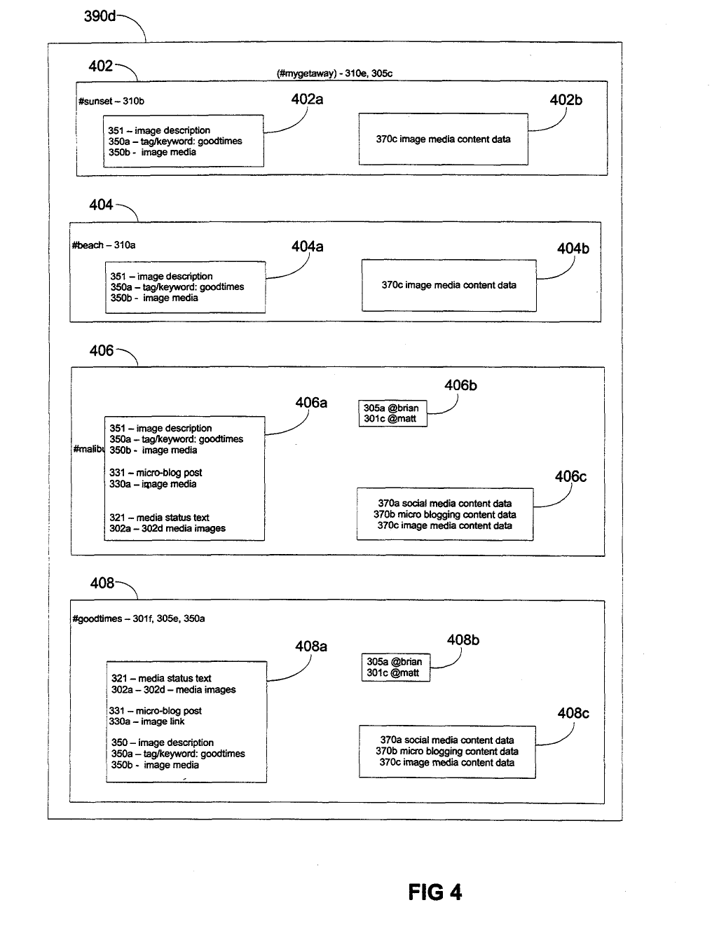

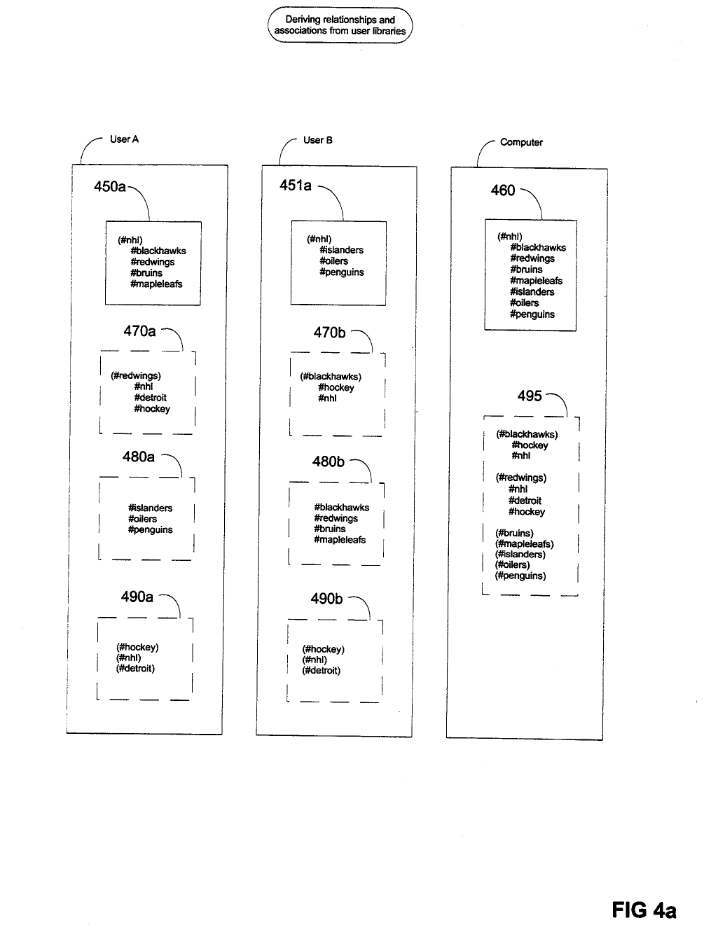

Looking next to FIG. 4, there is shown a diagrammatic illustration of the grouping identifiers, their related user identifiers, network details and elements that are associated with a single parent grouping identifier in accordance with one specific implementation of the present invention. This figure is an expanded view of FIG. 3A's reference numeral 390d.

In this example, the parent grouping identifier “(#mygetaway)” 310e, 305c from 390d contains the grouping identifiers “#sunset” 310b, “#beach” 310a, “#malibu” 305b, 310c, 301e and “#goodtimes” 305e, 350a, 301f.

The grouping identifier “#sunset” 310b contains the associations with image description 351, tag/keyword: goodtimes 350a and image media 350b as shown in 402a. The image media content server data 370c is associated with the grouping identifier “#sunset” 310b as shown in 402b. This associated data is a collection of elements that were parsed via process 200 of FIG. 2, from event 4 in FIG. 3. The grouping identifier “#sunset” 310b may or may not have additional associations.

The grouping identifier “#beach” 310a contains the associations with image description 351, tag/keyword: goodtimes 350a and image media 350b as shown in 404a. The image media content server data 370c is associated with the grouping identifier “#beach” 310a as shown in 404b. This associated data is a collection of elements that were parsed by process 200 of FIG. 2, from event 4 in FIG. 3. The grouping identifier “#beach” 310a may or may not have additional associations.

The grouping identifier “#malibu” 301e, 305b, 310c contains the associations with image description 351, tag/keyword: goodtimes 350a, image media 350b, micro-blog post 331, image media 330a, media status text 321 and image elements 302a-302d as shown in 406a. The user identifiers “@brian” 305a and “@chad” 301c are also associated with the grouping identifier “#malibu” 305b, 310c, 301e as shown in 406b. The social media content server data 370a, micro-blog content server data 370b and image media content server data 370c is associated with the grouping identifier “#malibu” 305b, 310c, 301e as shown in 406c. This associated data is a collection of elements that were parsed from event 1, event 2 and event 4 in FIG. 3. The grouping identifier “#malibu” 301e, 305b, 310c may or may not have additional associations.

User Identifiers 406b that are parsed from an object, retain their original associations with that identified user's content server data 406c. For example, a library entry that has been automatically pulled from a user's Twitter account that contains user identifier “@chad”, retains its original link back to “@chad” on Twitter. The “@chad” Twitter account details are cross-referenced with account details on the library content server. If a match has been made, then that library entry is also associated with @chad's account on the library content server.

The grouping identifier “#goodtimes” 301f, 305e, 350a contains the associations with media status text 321 and media images 302a-302d, micro-blog post 331, URL element 330a, image description 351, tag/keyword: goodtimes 350a and image media 350b as shown in 408a. The user identifiers “@brian” 305a and “@chad” 301c are also associated with the grouping identifier “#goodtimes” 301f, 305e, 350a as shown in 408b. The social media content server data 370a, micro-blog content server data 370b and image media content server data 370c is associated with the grouping identifier “#goodtimes” 301f, 305e, 350a as to shown in 408c. This associated data is a collection of elements that were parsed [FIG. 2. process 200] from event 1, event 2 and event 4 in FIG. 3. User Identifiers 408b that are parsed from an object, retain their original associations with that identified user's content server data 408c. For example, a library entry that has been automatically pulled from a user's Twitter account that contains user identifier “@chad”, retains its original link back to “@chad” on Twitter. The “@chad” Twitter account details are cross-referenced with account details on the library content server. If a match has been made, then that library entry is also associated with @chad's account on the library content server.

FIG. 4A is a list of other examples of some hierarchies built from parent grouping identifiers and grouping identifiers. For example, under the parent grouping identifier “(#nhl)” a user has organized objects with the grouping identifiers “#blackhawks”, “#redwings”, “#bruins” and “#mapleleafs” as shown in 450a. By forming this hierarchy the user has created the association between the grouping identifiers that they each belong to the “(#nhl)”. From this information, the invention is able to learn and understand that “#blackhawks”, “#redwings”, “#bruins”, and “#mapleleafs” are part of the “(#nhl)”. Other information can be derived from the context of the hierarchy and objects contained within. The invention can compare other grouping identifiers from the objects to improve context awareness. For example, a user may have also tagged many of the objects with grouping identifier “#hockey”, from this, the invention can infer that “#blackhawks”, “#redwings”, “#bruins” and “#mapleleafs” relate to hockey in some way. The invention can compare parent grouping identifiers and the contained grouping identifiers created by users across the system to learn further relations between the identifiers. For example, when comparing 450a from one user and 451a from a different user, the invention can infer that the parent grouping identifier (#nhl) is related to all of the following grouping identifiers: “#blackhawks”, “#redwings”, “#bruins”, “#mapleleafs”, “#islanders”, “#oilers” and “#penguins”. The user with the hierarchy 450a might be interested in objects from the second user's hierarchy 451a and vice versa. These relations can be used to suggest related objects a user might be interested in as well as to further define the elements contained within the objects. The invention can also compare how other users of the invention have tagged the same objects. When looking at this data, the invention is able to learn what the objects mean.

This example also illustrates how a computer system can derive relationships and associations by comparing the contents of a parent grouping identifier between multiple users. For example, the computer system finds the parent grouping identifier “(#nhl)” from User A's library as shown in 450a. The computer system then finds the parent grouping identifier “(#nhl)” from User B's library as shown in 451a. Then a comparison is made between User A's “(#nhl)” and User B's “(#nhl)” to build a complete set of unique grouping identifiers associated with both users' parent grouping identifier “(#nhl)” as shown in 460.

The computer system then takes each grouping identifier from the complete set of all grouping identifiers associated with the parent grouping identifier “(#nhl)” 460 and re-identifies each grouping identifier into a new parent grouping identifier as shown in 495. Then for each newly created parent grouping identifier the process of building a complete set of unique grouping identifiers is repeated.

For example, the computer system has re-identified the grouping identifier “#blackhawks” from the parent grouping identifier “(#nhl)” 460 into a new parent grouping identifier “(#blackhawks)” 495. The computer system then finds the parent grouping identifier “(#blackhawks)” in User B's library 470b and then builds a complete set of unique grouping identifiers associated with the newly created parent grouping identifier “(#blackhawks)” 495.

For another example, the computer system has re-identified the grouping identifier “#redwings” from the parent grouping identifier “(#nhl)” 460 into a new parent grouping identifier “(#redwings)” 495. The computer system then finds the parent grouping identifier “(#redwings)” in User A's library 470a and then builds a complete set of unique grouping identifiers associated with the newly created parent grouping identifier “(#redwings)” 495.

With the newly created complete set of grouping identifiers associated with the parent grouping identifier “(#nhl)” 460 the computer system can determine the missing grouping identifiers from User A's parent grouping identifier “(#nhl)” 450a and suggest these grouping identifiers as shown in 480a. This process is repeated for User B as shown in 480b.

The processes done in 480a and 480b can also be applied and repeated by re-identifying all grouping identifiers into parent grouping identifiers. These newly created parent grouping identifiers can be suggested to User A and User B as shown in 490a and 490b.

The order of the suggested grouping identifiers and parent grouping identifiers may be ordered by frequency of use, proximity, rank, geo-location, date and time, users, user source, and/or a multitude of other factors that adds any value to the user. By combining the associations, relationships, and data derived from the computer system's processes, identifiers' context and meaning can be defined.

FIG. 5 is a flow chart illustrating the hierarchy of a user library 502 in accordance with one aspect of the present invention. A user library 502 consists of the parent grouping identifiers 504, grouping identifiers 508, library entries 510, content sever data 512, elements 514 and the user identifiers 516. The parent grouping identifiers 504 contain the grouping identifiers 508. Not all grouping identifiers 508 will be associated with a parent grouping identifier 504. The grouping identifiers 508 contain the library entries 510 associated with those identifiers. Not all library entries 510 will be associated with a grouping identifier 508. The library entries 510 contain the content sever data 512, elements 514 and the user identifiers 516 associated with them.

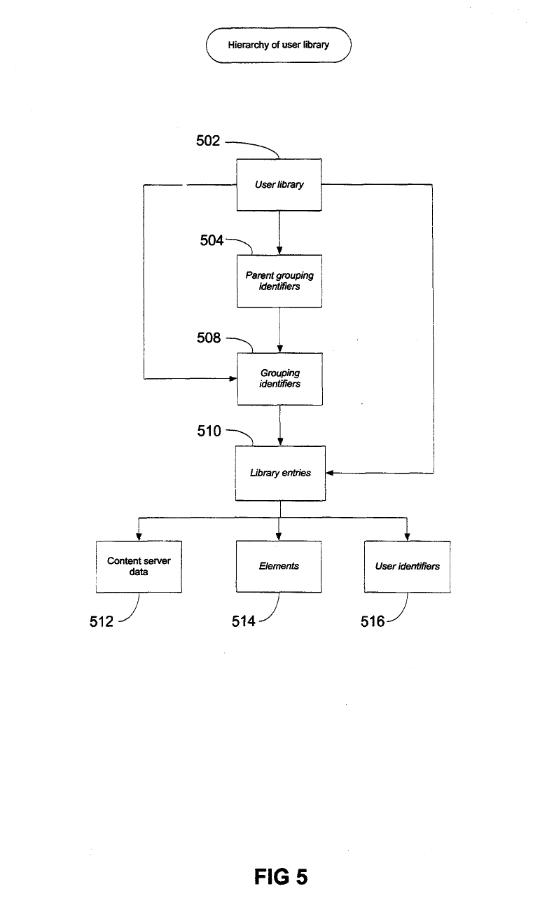

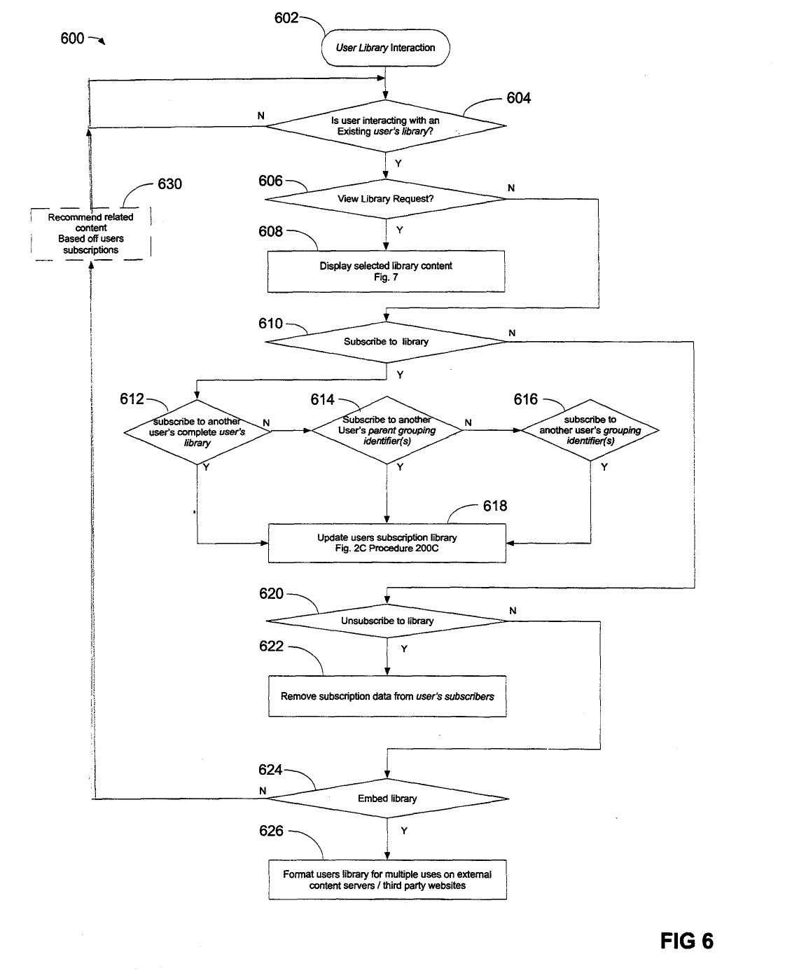

FIG. 6 illustrates another aspect of the present invention in which a process 600 shows how a user interacts with a user library in accordance with this aspect of the present invention. As an initial step 602, it is determined whether a user is interacting with an existing user's library in operation 604. For example, a user may select and interact with a particular user library using an interface via network 104. It is then determined whether the user is viewing the library 606. If such a request has been received, then at least a portion of the selected user's library may be displayed to the requesting user in operation 608. Otherwise this operation may be skipped. It is next determined whether the user is subscribing to the user's library 610. If such a request has been received, the details of the subscription are then determined using operations 612, 614, 616. The user has the option to subscribe to the complete user library 612, specific parent grouping identifiers from the user library 614, or specific grouping identifiers from the user library 616. The subscribing user's subscription library is then updated in operation 618, via FIG. 2C's procedure 200c, with objects from the subscription requested. This association is retained for future updates. Otherwise these operations may be skipped. It is next determined whether the user is unsubscribing 620 to a complete user's library, parent grouping identifier, grouping identifier or user identifier. If such a request has been received, the subscribing user's subscription details are modified or completely removed from the library database 110. The subscribing user's subscription library is updated to reflect the newly modified subscription details. Otherwise this operation may be skipped. It is next determined whether a users library is being embedded 624 in any content server of the users choosing. The resulting request to embed defines the method of formatting and aggregating 626 the user's library to external content servers. This aggregated data can include but is not limited to the complete user's library, parent grouping identifiers, grouping identifiers, user identifiers, the associated elements and content server network data. Otherwise, this operation may be skipped.

In one example, a user may be viewing a user's library under the parent grouping identifier “(#skate)”. “(#skate)” has the identifiers “#ramp” and “#bigair” associated with it. The library content sever 106 can then recommend 630 other user's library content and users based off the similarly identified parent grouping identifiers, grouping identifiers, user identifiers and content server data.

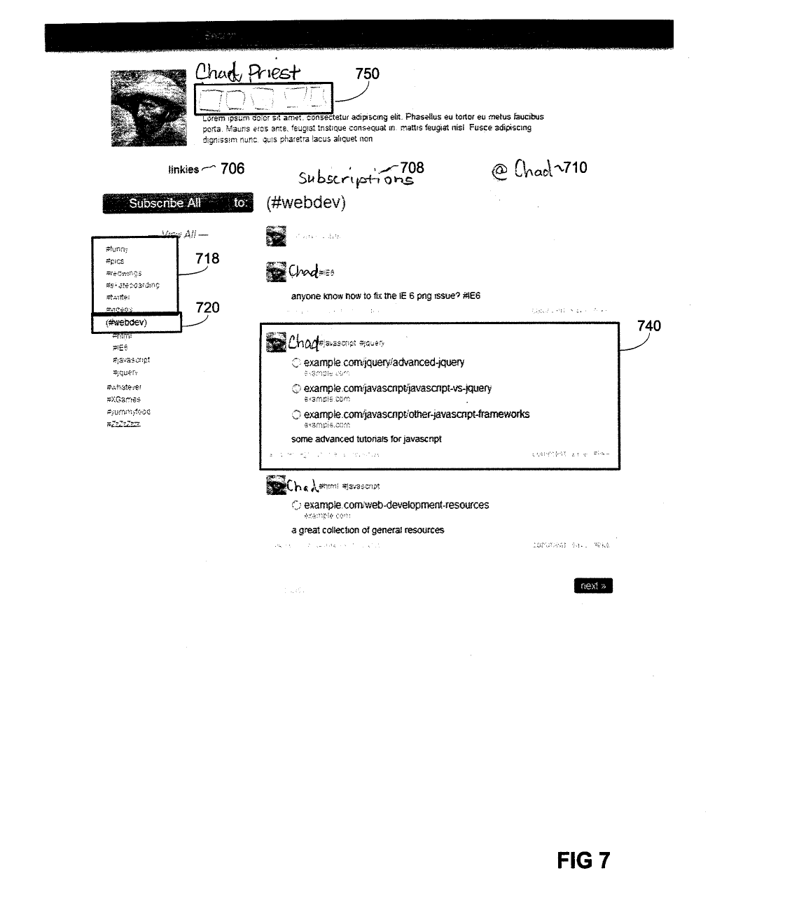

FIG. 7. is an example user library profile view in accordance with one aspect of the present invention. This is a single user library page showing stored library entries with all associated elements, parent grouping identifiers and grouping identifiers. In this example, the activity tab 706 displays stored library entries by the user Chad Priest. This user's library entries have been identified, grouped and sorted by using parent grouping identifiers 720 and grouping identifiers 718 and 721. Depending on the current identifier selected, the center pane will display the library entries that are associated with the identifier. For example, the current view is displaying the parent grouping identifier “(#webdev)” 720, its associated grouping identifiers “#html, #IE6, #javascript, #jquery” 721 and it's library entries and it's associated elements. 740 is a single library entry for the user Chad Priest that shows the identifiers and elements associated with it.

In another example, the user could select the subscriptions tab 708 and view all the user Chad Priest's subscriptions that he has other user's complete user libraries, parent grouping identifiers 718 and grouping identifiers 720. These identifiers could be formatted to the same way as the activity tab 706. The identifiers, when clicked on, will display the associated library entries and associated elements for all the different users he is subscribed to.

The same concept as above applies for the @chad tab 710. The only difference in this view is that it would display other users' library entries that have been directed at Chad Priest's user identifier. The identifiers could be formatted the same way as the activity tab 706. In this example, the content servers that Chad Priest has connected to his user library are displayed with a logo and link directly 750 to his content server profile pages.

Other example views might include but are not limited to: subscription, analytic dashboards, rank, related items and trending. Rank can determine order and/or organization of parent grouping identifiers, grouping identifiers, user identifiers, objects. Related items are a mix of parent grouping identifiers, grouping identifiers, user identifiers and/or objects and its associated elements. Analytic dashboards display the graphs, charts, ranks and figures or any other visual representation of retained objects, identifiers, group identifiers, parent grouping identifiers, user identifiers, elements values or data, based on any number of factors including but not limited to: frequency of use, rank, related, trending, proximity, geo location, date and time, users, user source, and or a multitude of other factors that adds any analytic value. Trending views are based on any number of factors including but not limited to: frequency of use, rank, related, trending, proximity, geo location, date and time, users, user source, and or a multitude of other factors that adds any value to the user. All views may or may not include advertisements, including but not limited to, banners, flash, bid-based, promoted parent grouping identifiers, promoted grouping identifiers, promoted objects or elements.

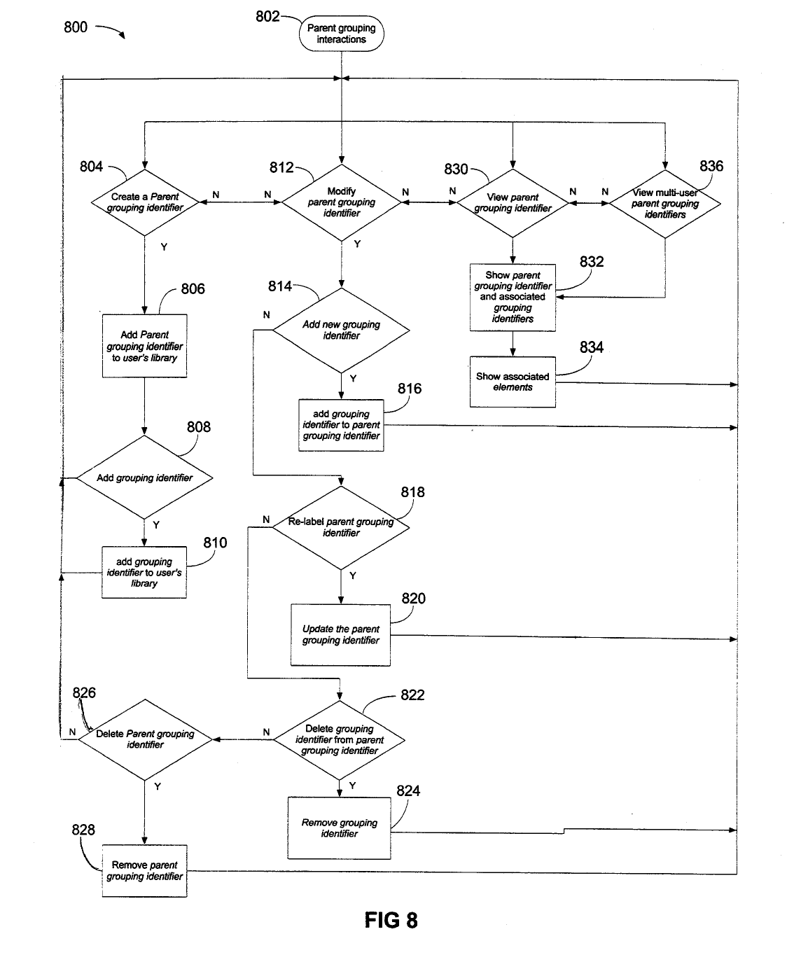

FIG. 8. illustrates a procedure 800 in which a user is interacting with parent grouping identifiers in accordance with yet another aspect of the present invention. As an initial step, it is determined whether a user is creating a new parent grouping identifier 804. If such a request has been received, the parent grouping identifier is created in a user's library 806 and the user is prompted to associate grouping identifiers 808 with the newly created parent grouping identifier. The associated grouping identifiers are then stored 810 in the user's library. Otherwise this operation may be skipped. It is next determined whether the user is modifying a parent grouping identifier 812. If such a request has been received it is then determined if the user wishes to add grouping identifiers to the parent grouping identifier 814. The associated grouping identifiers are then stored 816 in the user's library. Otherwise this operation may be skipped. It is next determined whether the user wishes to re-label the parent grouping identifier 818. If such a request has been received, the new parent grouping identifier label is stored 820 in the user's library and the associated grouping identifiers remain the same. Otherwise this operation may be skipped. It is next determined whether the user is deleting a grouping identifier from a parent grouping identifier 822. If such a request has been received, the selected grouping identifier is removed from the parent grouping identifier 824. Otherwise this operation may be skipped. It is next determined whether the user wishes to delete the parent grouping identifier 826. If such a request has been received, the selected parent grouping identifier is deleted and the associations to grouping identifiers are dissolved 828 from the user's library. Otherwise this operation may be skipped. It is next determined whether the user wishes to view a parent grouping identifier 830. If such a request has been received, then the parent grouping identifier and the associated grouping identifiers are displayed to the user 832. Elements related to the library entry are also displayed to the user 834. Otherwise this operation may be skipped. It is next determined whether the user wishes to view parent grouping identifiers from multiple users 836. If such a request has been received, then the parent grouping identifiers from multiple users and their associated grouping identifiers are displayed to the user 832. Elements related to the library entry are also displayed to the user 834. Otherwise this operation may be skipped.

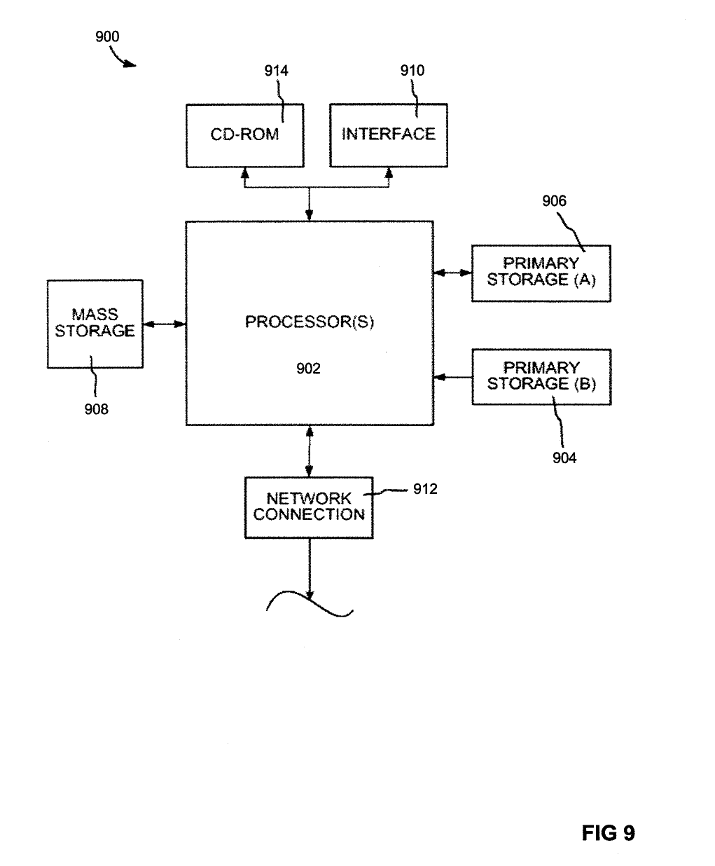

FIG. 9 illustrates a typical computer system that, when appropriately configured or designed, can serve as a user library server 106. The computer system generally denoted by numeral 900 may include any number of processors 902, also known as central processing units, or CPUs, that are coupled to storage devices including primary storage 906 (typically a random access memory, or RAM), primary storage 904 (typically a read only memory, or ROM), CPU 902 may be of various types including microcontrollers and microprocessors such as programmable devices (e.g., CPLDs and FPGAs) and un-programmable devices such as gate array ASICs or general-purpose microprocessors. Primary storage 904 acts to transfer data and instructions uni-directionally to the CPU and primary storage 906 is used typically to transfer data and instructions in a bi-directional manner. Both of these primary storage devices may include any suitable computer-readable media such as those described herein. A mass storage device 908 is also coupled bi-directionally to CPU 902 and provides additional data storage capacity and may include any of the computer-readable media described herein. Mass storage device 908 may be used to store programs, data and the like and is typically a secondary storage medium such as a hard disk, it will be appreciated that the information retained within the mass storage device 908, may, in appropriate cases, be incorporated in standard fashion as part of primary storage 906 as virtual memory. A specific mass storage device such as a CD-ROM 914 may also pass data uni-directionally to the CPU.

Still referring to FIG. 9, CPU 902 may also be coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications network using an external connection as shown generally at 912. With such a connection, it is contemplated that the CPU might receive information from the network, or might output information to the network in the course of performing the method steps described herein.

Regardless of the system's configuration, it may employ one or more memories or memory modules configured to store data and program instructions for the general-purpose processing operations and/or the inventive techniques described herein. The program instructions may control the operation of an operating system and/or one or more applications, for example. The memory or memories may also be configured to store library entries, identifiers, elements, user libraries, a user's library index, statistics, or the like.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

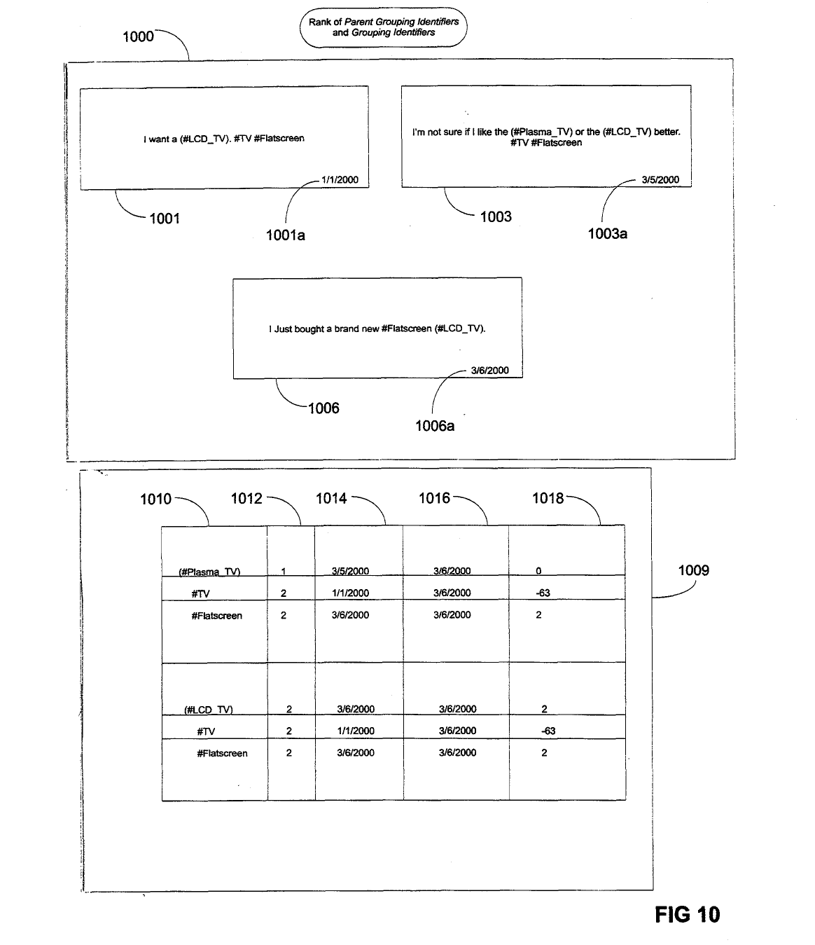

FIG. 10 is a diagrammatic illustration of three example posts 1000 found or inserted into a user library and a sample data store structures storing 1009 the parent grouping identifier and the grouping identifier with an example applied rank. In one example, the post 1001 has a date 1001a of Jan. 1, 2000, along with the parent grouping identifier (#LCD_TV) and grouping identifiers #TV and #Flatscreen. In another example, the post 1003 has a date 1003a of Mar. 5, 2000, with parent grouping identifiers (#LCD_TV) and (#Plasma_TV) and grouping identifiers #TV and #Flatscreen. In yet another example, the post 1006 has a date 1006a of Mar. 6, 2000, with a parent grouping identifier (#LCD_TV) and grouping identifier #Flatscreen. Within the example, data store table 1009, the parent grouping identifiers and the grouping identifiers from the posts 1000, are shown in column 1010. Column 1012 represents the count of the user's and/or global usage of parent grouping identifiers and grouping identifiers represented in column 1010. Column 1014 shows the original posting date of the parent grouping identifier or the grouping identifier. Column 1016 shows the latest updated date of the parent grouping identifier or the grouping identifier. Column 1018 shows the applied rank of the parent grouping identifier and the grouping identifier that is determined by an algorithm with any and all possible data associated with that object.

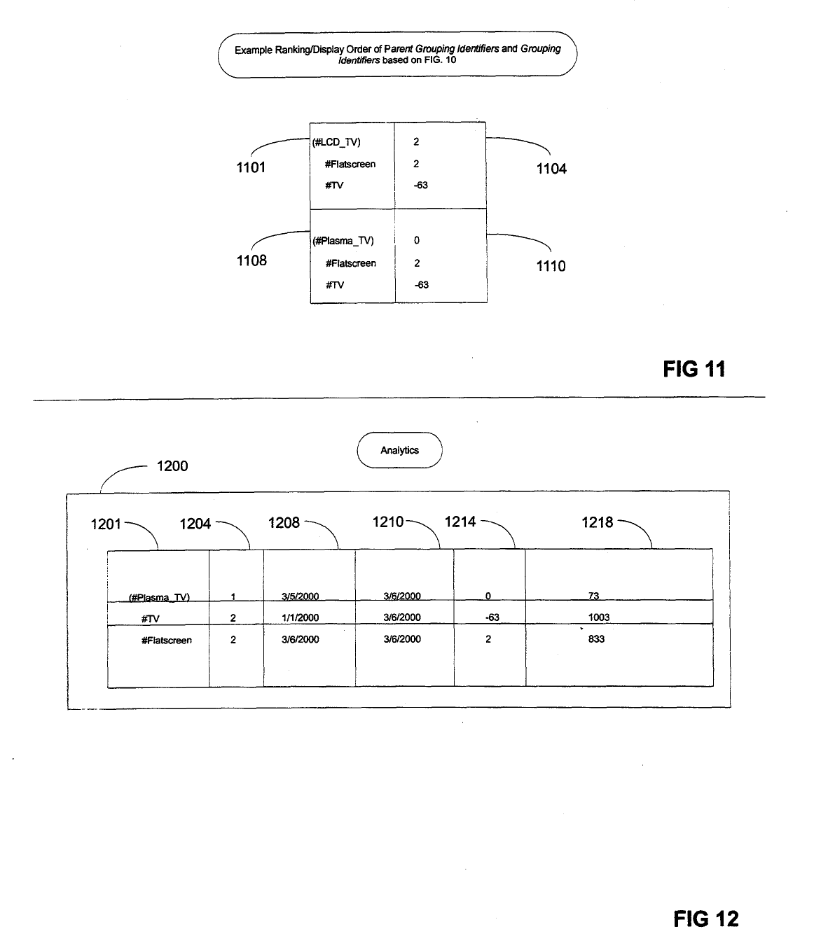

FIG. 11 Is a diagrammatic illustration of how the parent grouping identifiers and grouping identifiers may be displayed based on rank. The first example shows a list of parent grouping identifiers with its associated grouping identifiers 1101 ordered by rank 1004. The second example shows a list of parent grouping identifiers with its associated grouping identifiers 1108 ordered by rank 1110.

FIG. 12 is a diagrammatic illustration of an example data store table 1200 with some of the parent grouping identifiers and the grouping identifiers from the posts 1000 of FIG. 10 are shown in column 1201. Column 1204 represents the count of the user's and/or global usage of parent grouping identifiers and grouping identifiers represented in column 1201. Column 1208 shows the original posting date of the parent grouping identifier or the grouping identifier. Column 1210 shows the latest updated date of the parent grouping identifier or the grouping identifier. Column 1214 shows the applied rank of the parent grouping identifier and the grouping identifier that is determined by an algorithm. Column 1218 shows the click through rate of each parent grouping identifier and grouping identifier.

This data may be used to display the analysis of parent grouping identifier and grouping identifier use to someone or to another computer through an API or other method of data. This data may be represented in any form including but not limited to: line graphs, pie graphs, text, pictures, illustrations, or any other representations of data.

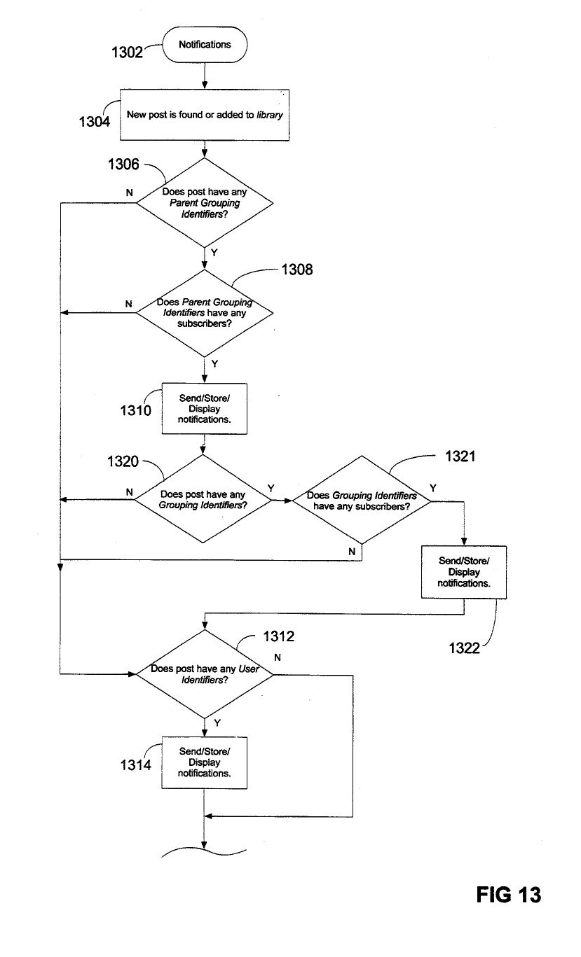

FIG. 13 is a flow chart illustrating a notification system for subscriptions to parent grouping identifiers and grouping identifiers and user identifier mentions. In the example, flow chart a new post is found or added to a users library 1302. The process checks to see if there are any parent grouping identifiers within the new object 1306. Then the process checks to see if there are any subscribers to the parent grouping identifier 1308. If any subscribers are found then the process by sending, storing and/or display a notification 1310 of the new object to the subscriber.

The process then checks to see if there are any grouping identifiers within the elements of the new object 1320. Then the process checks to see if there are any subscribers to the grouping identifier 1321. If any subscribers are found then the process will send, store and/or display a notification 1322 of the new object to the subscriber. Now the process checks to see if there are any user identifiers within the elements of the new object 1312. Then the process will send, store and/or display a notification 1314 of the new post to the specified user identifier found.

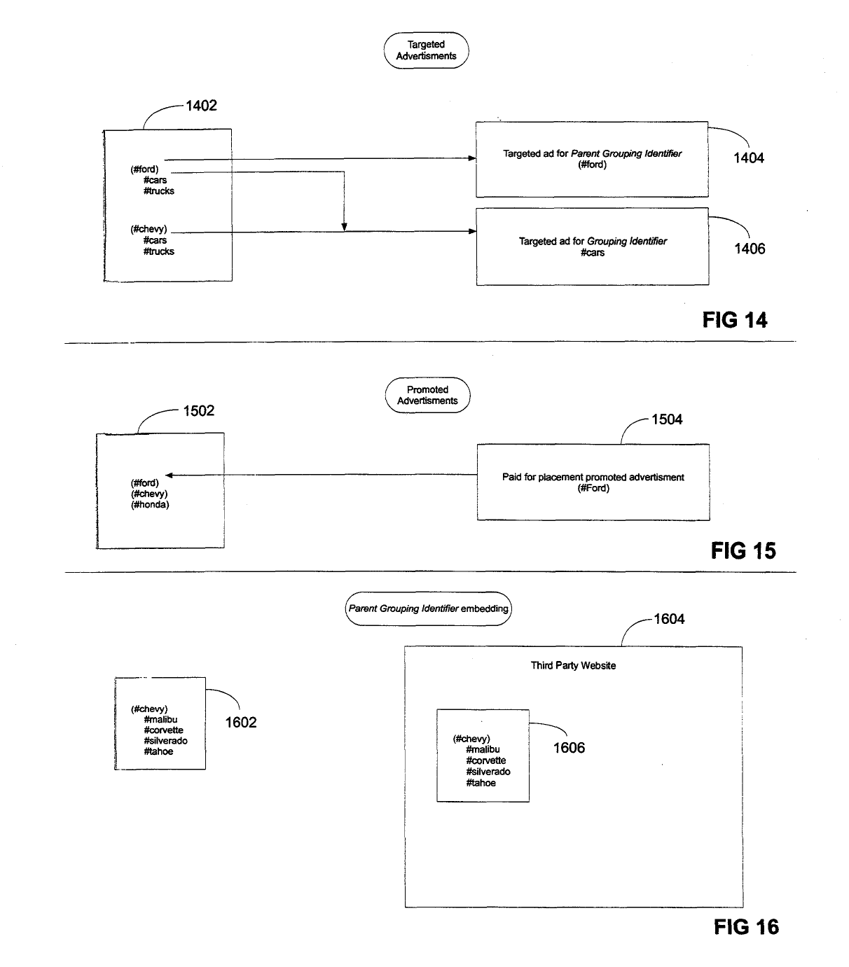

FIG. 14 is a diagrammatic illustration of how targeted advertisements may be associated and displayed for parent grouping identifiers and grouping identifiers. In this example illustration an advertiser has purchased an ad spot 1404 for the parent grouping identifier (#ford) found within a collection of identifiers 1402. When this collection 1402 or any other collection that contains the parent grouping identifier (#ford) or the other grouping identifiers contained therein is viewed by a user, then the advertiser's advertisement may be served to the end user.

In the next example illustration, an advertiser has purchased an ad spot 1406 for the grouping identifier #cars found within a collection of identifiers 1402. When this collection 1402 or any other collection that contains the grouping identifier #cars or the grouping identifier #cars is contained within an associated parent grouping identifier, then the advertiser's advertisement may be served to the end user.

The specified grouping identifier that the advertiser has selected to associate an advertisement with may also serve the advertisement if the grouping identifier is part of what makes up a parent grouping identifier. For example, there might be a grouping identifier #cars associated with an advertisement. That same advertisement might also be served for the parent grouping identifier (#fast_cars) because the term “cars” is found within the string “fast_cars”.

FIG. 15 is a diagrammatic illustration of how promoted advertisements may be displayed for parent grouping identifiers. In this example an advertiser has purchased a promoted parent grouping identifier (#ford) 1504. The promoted parent grouping identifier (#ford) will then be displayed within a collection of other identifiers 1502 when a user views a page. This example includes the promoted parent grouping identifier highlighted with an asterisk before the term. The highlight is optional.

FIG. 16 is a diagrammatic illustration of parent grouping identifiers and it's grouping identifiers being embedded on a third party website. Here is a collection of identifiers 1602 that a user may want to display on a third party website 1604. This collection of parent grouping identifiers and/or grouping identifiers may contain all the objects that are associated with it. If the user chooses to display this information on a third party website 1604 then computer code can be provided that will allow the user to embed the collection of identifiers 1606 on any third party website 1604. This embed code usually consist of but is not limited to html and javaScript.

A bid-based advertising system can be placed on grouping identifiers and parent grouping identifiers. Advertisers will bid to promote their advertisements along side search results and/or user libraries by using grouping identifiers and/or parent grouping identifiers to reach their target demographic. Other information can also be used to target the advertisements such as subscription details, profile information, location, etc. Premium to accounts can be sold for a subscription fee. Premium accounts will allow extended features of the invention, such as profile customization options, multiple logins for one account, analytics, etc. Application Programming Interface, or API, credits can be purchased to implement features of the invention to other applications.

Businesses can also purchase the rights to customize the appearance of content shared from their site. When a user creates a library entry with elements from a specific website, the owner of that website can purchase the rights to customize how those elements are displayed in the user's library. For example, an online newspaper could purchase the rights to control what content from their article is shared in the user's library and also how this content is displayed when a user shares a link from their site.

Businesses can also use our invention as a content distribution network. This would allow them to sell access to content on the invention. Objects under chosen identifiers would be behind a pay-wall. Users wishing to view the content or subscribe to the content would be required to pay a fee. The invention would manage billing and access rights to the content. Certain fee-based subscriptions would be made available.

Possible commercial or industrial subscribers may want certain types of information, including such arenas as medical diagnosis, record keeping, insurance risk assessment applications, and all other types of commercial enterprises are also envisioned where parent grouping identifiers will be defined, for example for various diseases or insurance applications, such that they can be analyzed and the data managed to be useful in those industries. All other industries might find similar useful applications for data in their fields. The data can be user-defined inline into a hierarchical ranking that yields useful results for analysis.

In general, in order to derive a hierarchical structure from an element or multiple elements of an object, the software will locate objects from local data storage, remote data storage or any computer or any data source, determine by the computer certain elements of an object, then determine, by the computer, the parent grouping identifier, grouping identifier, and user identifier of a single element or multiple elements.

Then, the computer determines the hierarchy of the parent grouping identifiers, its children grouping identifiers and the children objects of the grouping identifiers with the children elements of the objects, and then the computer stores the hierarchy and/or the parent grouping identifier and/or grouping identifier and/or user identifier and/or elements of an object into computer memory.

Within the software, the objects are made up of data elements, and the elements are attributes of an object made up of any of syntax, parent grouping identifiers, grouping identifiers, user identifiers or any other identifiers, text, URL, identifiers, String, floating point, Binary, media, pictures, video, audio, and the like of an object.

Further, the parent grouping identifier is a computer or user-defined inline element of an object based on parent grouping syntax, and the grouping identifier is a computer or user-defined inline element of an object based on grouping syntax, while the user identifier will be a computer or user-defined inline element of an object based on user identifier syntax.

Storing of the information includes retaining instructions on a computer readable storage for a computing system including, but not limited to, RAM, disk, flash, string, file, or any suitable memory means.

In another aspect of the present invention, the creation and updating of a user library can be based on a hierarchy of at least one parent grouping identifier, at least two of its children grouping identifiers and/or user identifiers and children objects of the grouping identifiers and the children elements of the objects. The computer determines the definition, context and meaning of identifiers. The user library is displayed based on the hierarchy of the parent grouping identifiers, its children grouping identifiers and/or its user identifiers, as well as the children objects of the grouping identifiers and the children elements of the objects.

In addition, a subscription system, by the computer, may store subscriptions to parent grouping identifiers, grouping identifiers, user identifiers and/or the users of a user library. These parent grouping identifiers, grouping identifiers, user identifiers and/or objects and its associated elements for the subscriptions may be displayed to allow for searching for objects and their associated elements based on the hierarchy of the parent grouping identifiers, its children grouping identifiers and/or user identifiers. The computer may also alert users of new objects associated with their subscription by a notification system, which may also alert users of new objects associated with their user identifier.

The computer may then determine, display, and relate the rank of parent grouping identifiers, grouping identifiers, user identifiers and/or objects and their associated elements. Thereafter, these various related identifier groups and elements can be analyzed, and the results of that analysis can be displayed. For example, the display may be of advertisements based on the various identifiers and objects or elements. Providing embedding code can allows users to display parent grouping identifiers, their grouping identifiers and/or all children objects and associated elements within a third party website.

In further aspects of the present invention, a user library may consists of a collection of organized and stored associations to objects, identifiers, grouping identifiers, parent grouping identifiers, content server data, user identifiers, files, folders, instructions and elements. After identified, the computer may display any representation of the objects, identifiers, grouping identifiers, parent grouping identifiers, content server data, user identifiers, files, folders, instructions and elements allowing a requesting user the ability view the requested content on any digital medium or any digital device.

Some users may wish to use a subscription system that will allow for the delivery, or displaying of the requested content associated with any objects, identifiers, grouping identifiers, parent grouping identifiers, content server data, user identifiers, files, folders, instructions and elements. A search system may be implemented to display data results based on a computer or user-defined query, while an optional notification system can provide a delivery system to display an alert associated with a subscription or user-identifier. Users would be any entity requesting data.

Ranking of the information can be determined by frequency of identifiers' use, proximity, geolocation, date and time, users, user sources, and/or a multitude of other factors that adds relevancy value. Relation of the information can either be user defined or computer determined for relationships between objects, identifiers, grouping identifiers, parent grouping identifiers, content server data, user identifiers, files, folders, instructions and elements, while the analysis of the information is determined by the data derived from the frequency of use, proximity, geo location, date and time, users, user source, computer processes and/or a multitude of other factors that adds any analytic value from parent grouping identifiers, grouping identifiers, user identifiers and/or objects and its associated elements. Certain analytics will allow the display of graphs, charts, ranks and figures or any other visual representation of retained objects, identifiers, group identifiers, parent grouping identifiers, user identifiers, elements values or data, based on any number of factors including to but not limited to: frequency of use, proximity, geolocation, date and time, users, user source, and or a multitude of other factors that adds any analytic value.

When embedding of code is necessitated, computer code, usually in the form of, but not limited to, html and JavaScript computer programming languages, allows the displaying of parent grouping identifiers, their grouping identifiers and/or all children objects and associated elements on third party websites.

The foregoing description of a preferred aspect of the invention has been presented for purposes of illustration and description. It is not intended to be exhaustive or to limit the invention to the precise form disclosed. Obvious modifications or variations are possible in light of the above teachings with regards to the specific aspects. The aspect was chosen and described in order to best illustrate the principles of the invention and its practical applications to thereby enable one of ordinary skill in the art to best utilize the invention in various aspects and with various modifications as are suited to the particular use contemplated. It is intended that the scope of the invention be defined by the claims which are appended hereto.

### INDUSTRIAL APPLICABILITY

The present invention finds industrial applicability in the consumer computer industry, and finds particular applicability in the social networking media, medical diagnosis and the risk assessment insurance industries, among many others.

What is claimed is:

1. Software for deriving a hierarchical structure from an element or multiple elements of an object, comprising:
object location from storage from any data source;
determination of the elements of an object;
determination of a user identifier, a grouping identifier, and a parent grouping identifier, of at least one element;
determination of a hierarchy of the parent grouping identifiers, its children grouping identifiers, children objects of the grouping identifiers and children elements of the objects; and
storing the hierarchy of the parent grouping identifier, the grouping identifier, the user identifier, and the elements of an object into computer memory.
